(19) United States
(12) Patent Application Publication
(10) Pub. No.: US 2006/0078278 A1
(43) Pub. Date: Apr. 13, 2006

(54) Broadcast receiver and control method for the receiver

(75) Inventor: Teruo Tajima, Sawa-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/231,784

(22) Filed: Sep. 22, 2005

(30) Foreign Application Priority Data
Sep. 27, 2004 (JP) 2004-280702

(51) Int. Cl. H04N 5/76

(52) U.S. Cl. 386/46; 386/125

(57) ABSTRACT

A broadcast receiver comprises a connection terminal to which a plurality of video recording devices are connected, a library display means for displaying a library including program names of a plurality of programs recorded in arbitrarily selected video recording devices among the plurality of video recording devices, a retrieval screen display means for displaying a screen to which retrieval condition information to retrieve recorded programs is input, and a retrieval result display means for retrieving recorded programs matching to the retrieval conditions when retrieval conditions are input to the retrieval screen and displaying a program list including names of the retrieved programs matching the retrieval conditions, as a retrieval result screen.

### CROSS-REFERENCE TO RELATED APPLICATIONS

This application is based upon and claims the benefit of priority from prior Japanese Patent Application No. 2004-280702, filed Sep. 27, 2004, the entire contents of which are incorporated herein by reference.

### BACKGROUND OF THE INVENTION

1. Field of the Invention

The present invention relates to improvements in a broadcast receiver for receiving, for example, digital television broadcasting, etc., and more particularly, to a broadcast receiver with a plurality of video recording devices connected thereto, having a function to retrieve recorded programs.

2. Description of the Related Art

As is well known, in recent years, digitization of television broadcasting has accelerated. For example, in Japan, not only satellite digital broadcasting such as broadcasting satellite (BS) digital broadcasting and 110° communication satellite (CS) digital broadcasting but also terrestrial digital television broadcasting have started.

It has become possible for a digital broadcast receiver for receiving such digital television broadcasting to digitally record the received program or reproduce the recorded program by connecting a digital recording device with a large capacity such as a hard disk drive (HDD).

Nowadays, it is possible for a digital broadcast receiver to specify any digital recording device for recording a program and reproducing the recorded program by connecting a plurality of sets of digital recording devices to configure a network for a single digital broadcast receiver.

In such a broadcast receiver making the plurality of the digital recording devices connectable with a network thereto, it becomes important to allow a user to easily manage programs recorded in the respective digital recording devices and quickly retrieve a desired recorded program to reproduce it.

A configuration by which a television receiver with an Internet receiving function can recognize a connection state through a telephone line even if the television receiver outputs the sound of a television signal from its loudspeaker is disclosed in Jpn. Pat. Appln. KOKAI Publication No. 10-136275.

### BRIEF SUMMARY OF THE INVENTION

As described above, in the case that a broadcast receiver can connect a plurality of digital video recording devices thereto, the broadcast receiver requires to manage each video recording device, respectively. Since a recording medium becomes large in capacity, it is assuredly estimated that the number of programs which have already recorded in the video recording devices are significantly increased. In this case, a user has to make a great effort to retrieve the recorded programs.

The invention has been developed to solve the problems described above and an object of the invention is to provide a broadcast receiver for easily retrieve the recorded and desired program in the broadcast receiver to which a plurality of digital video recording devices are connected with a network.

According to one aspect of the present invention, there is provided a broadcast receiver comprises a library display means for displaying a library including names of a plurality of programs recorded in video recording devices which are arbitrarily selected among the plurality of video recording devices, a retrieval screen display means for displaying a screen to which retrieval condition information to retrieve recorded programs is input, and a retrieval result display means for retrieving the recorded programs matching to the retrieval conditions from recording information of the selected video recording devices and displaying a program list including the names of the matched programs, as a retrieval result screen. The retrieval result displaying means includes a means to display even the names of programs under recording while including the names thereof in the program list.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an embodiment of the invention and is a view for schematically explaining a digital television broadcast receiver and an example of a network system configured around the broadcast receiver as a center;

FIG. 2 is a block diagram for explaining a principal signal processing system of the broadcast receiver in the embodiment in FIG. 1;

FIG. 3 is an external view for explaining a remote controller of the broadcast receiver in the embodiment in FIG. 1;

FIG. 4 is a flowchart for explaining operations in the case that the broadcast receiver in the embodiment in FIG. 1 controls digital recording devices to record programs thereby;

FIG. 5 is a view for explaining an example of a program table displayed on a display unit connected to the broadcast receiver in the embodiment in FIG. 1;

FIG. 6 is a flowchart for explaining operations in the case that the program is reproduced from the recording device by the broadcast receiver in the embodiment in FIG. 1;

FIG. 7 is a view for explaining an example of a navigation menu displayed on the display unit when reproduction operations are performed in the broadcast receiver in the embodiment in FIG. 1;

FIG. 8 is a view for explaining a state in which items of video recorded programs are selected from the navigation menu;

FIG. 9 is a view for explaining an example of a list display screen which indicates recently recorded programs and can be obtained from the navigation menu;

FIG. 10 is a view for explaining an example of a connected device list display screen of the broadcast receiver in the embodiment in FIG. 1;

FIG. 11 is a view for explaining an example of a list display screen of programs recorded in specific connected devices which are connected to the broadcast receiver in the embodiment in FIG. 1;

FIG. 12 is a view for explaining an example of recorded program retrieval operations of the broadcast receiver in the embodiment in FIG. 1;

FIG. 13 is a view for showing an example of the recorded program retrieval operations of the broadcast receiver in the embodiment in FIG. 1 and explaining the following of FIG. 12;

FIG. 14 is a view for showing an example of a display screen of a recorded program retrieval result of the broadcast receiver in the embodiment in FIG. 1;

FIG. 15 is a flowchart for more specifically explaining the recorded program retrieval operations of the broadcast receiver in the embodiment in FIG. 1;

FIG. 16 is a view for explaining an example of the recorded program retrieval screen of the recorded program retrieval operations in the embodiment in FIG. 1;

FIG. 17 is a view for explaining an example of a category setting screen of the recorded program retrieval operations in the embodiment in FIG. 1;

FIG. 18 is a view for explaining an example of a keyword setting screen of the recorded program retrieval operations in the embodiment in FIG. 1;

FIG. 19 is a view for explaining an example of a date setting screen of the recorded program retrieval operations in the embodiment in FIG. 1;

FIG. 20 is a view for explaining an example of a channel setting screen of the recorded program retrieval operations in the embodiment in FIG. 1;

FIG. 21 is a view for explaining an example of a retrieval side setting screen of the recorded program retrieval operations in the embodiment in FIG. 1;

FIG. 22 is a view for explaining an example of a recorded program retrieval result screen of the recorded program retrieval operations in the embodiment in FIG. 1; and

FIG. 23 is a flowchart for explaining operations to reproduce the programs selected from the recorded program retrieval result screen in the embodiment in FIG. 1.

### DETAILED DESCRIPTION OF THE INVENTION

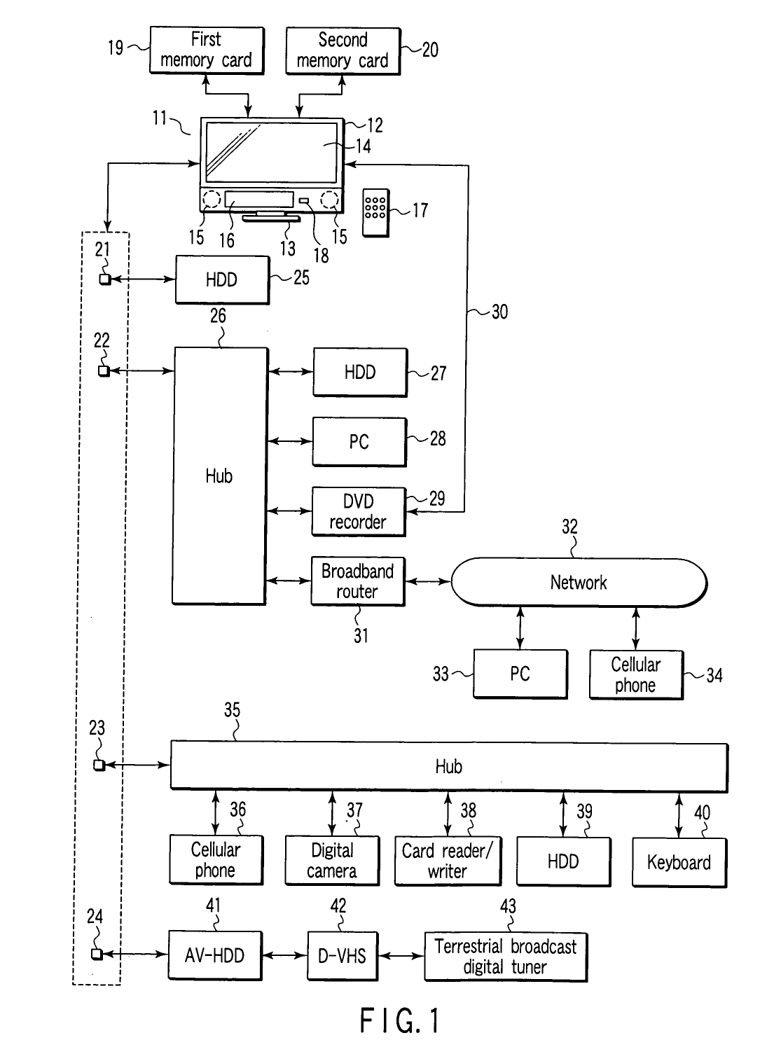

Hereinafter, embodiments of the invention will be explained by referring the drawings in details. FIG. 1 schematically shows the external appearance of a digital television broadcast receiver 11 which will be explained in the embodiments and an example of a network system configured around the broadcast receiver 11 as a center.

The broadcast receiver 11 is composed mainly of a thin cabinet 12 and a support base 13 making the cabinet 12 raised and supported. The cabinet 12 is provided with a flat panel type video display unit 14 composed of a liquid crystal display panel or the like, a loudspeaker 15, an operation unit 16 and a light receiving unit (remote-controlled operation receiving unit) 18 and the like to receive operation information transmitted from a remote controller 17.

The broadcast receiver 11 is configured to detachably have a first memory card 19 being such as a secure digital (SD) memory card, a multimedia card (MMC) and a memory stick and perform recording/reproducing of information about such as a program or a photograph to and from the first memory card 19.

The broadcast receiver 11, further, detachably has a second memory card (IC card) 20 with, for example, contract information recorded thereon and performs recording/reproducing of information to and from the second memory card 20.

The broadcast receiver 11 is provided with a first local area network (LAN) terminal 21, a second LAN terminal 22, a universal serial bus (USB) terminal 23 and an i.Link (trade mark) terminal 24.

Among these terminals, the first LAN terminal 21 is used as a LAN-compatible HDD dedicated port. The first LAN terminal 21 is connected to a LAN-compatible HDD 25 being a network attached storage (NAS). The first LAN terminal 21 is used to record/reproduce information to and from the HDD 25 through Ethernet (registered trade mark).

As mentioned above, by providing the first LAN terminal 21 to be the LAN-compatible HDD dedicated port, the broadcast receiver 11 becomes able to stably perform information recording with a high image quality of the program to the HDD 25 without being influenced by other network environment or the status of use of the network.

The second LAN terminal 22 is used as a general LAN-compatible port using the Ethernet. The second LAN terminal 22 is connected to devices, for example, a LAN-compatible HDD 27, a personal computer (PC) 28 and a digital versatile disk (DVD) recorder 29 with a built-in HDD through a hub 26 via and used in information transmission between these devices and the broadcast receiver 11.

Digital information communicated through the second LAN terminal 22 being information of a control system, the DVD recorder 29 requires a dedicated analog transmission path 30 to transmit analog information of video and sound to the broadcast receiver 11.

The second LAN terminal 22 is connected to, for example, a network 32 such as the Internet via a broadband router 31 which is connected to the hub 26 and used to communicate information between a PC 33 or a cellular phone 34, etc., and the broadcast receiver 11 via the network 32.

The USB terminal 23 is used as a general USB-compatible port, connected to, for example, a cellular phone 36, a digital camera 37, a card reader/writer 38 for memory cards 19, 20, an HDD 39 and a keyboard 40 and used to make information transmission between the devices and the broadcast receiver 11.

The foregoing i.Link terminal 24 serially connects an AV-HDD 41, digital (D)-video home system (VHS) 42, etc. and makes the information transmission between the devices and the broadcast receiver 11.

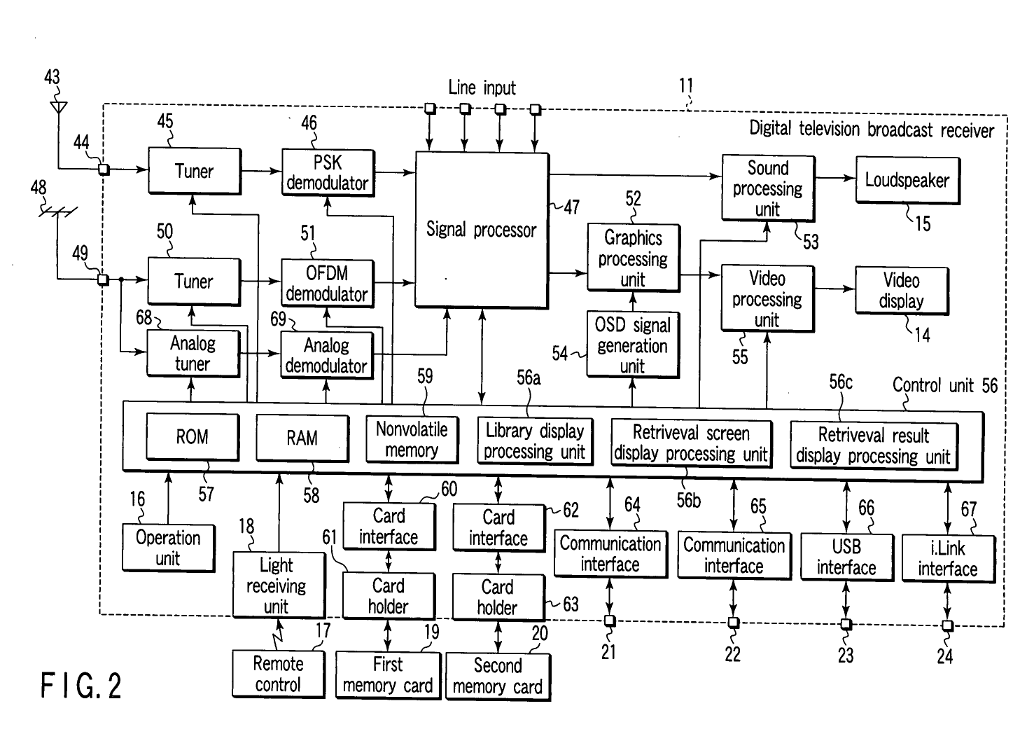

FIG. 2 shows the principal signal processing system of the foregoing broadcast receiver 11. That is, a satellite digital television broadcast signal received at an antenna 43 for receiving BS/CS digital broadcast is supplied to a tuner 45 for satellite digital broadcasting through an input terminal 44, and the tuner 45 tunes a broadcast signal of a desired channel.

The broadcast signal tuned by the tuner 45 is fed to a phase shift keying (PSK) demodulator 46 and demodulated to a digital video signal then digital sound signal is output to a signal processor 47.

The signal processing system also includes an analog tuner 68 for receiving a terrestrial analog signal. A signal received by the analog tuner 68 is demodulated by an analog demodulator 69 and output to a signal processing unit 47.

A terrestrial digital television broadcast signal received at an antenna 48 for receiving terrestrial digital television broadcasting is supplied to a tuner 50 for the terrestrial digital television broadcast via an input terminal 49, and the tuner 50 tunes the broadcast signal of the desired channel.

The broadcast signal tuned by the tuner 50 is supplied to an orthogonal frequency division multiplexing (OFDM) demodulator 51 to be demodulated to a digital video signal and a digital sound signal then output to a signal processing unit 47.

This signal processing system also has an analog tuner 68 to receive a terrestrial wave analog signal. The signal received by the analog tuner 68 is demodulated by an analog demodulator 69 and output to the signal processing unit 47.

The signal processing unit 47 selectively conducts prescribed digital signal processing to the digital video signals and sound signals supplied from the PSK demodulator 46 and supplied from the OFDM demodulator 51, and the video signals and analog signals supplied from the analog demodulator 69 and further supplied from the line input terminals. Then the signal processing unit 47 outputs the digitally processed signals to a graphics processing unit 52 and a sound processing unit 53.

Among these processing units, the graphics processing unit 52 has a function to superimpose an on screen display (OSD) signal generated from an OSD signal generator 54 on the digital video signal supplied from the signal processing unit 47 and output the superimposed signal. The graphics processing unit 52 can selectively output the video signal output from the signal processing unit 47 and the OSD signal output from the signal generator 54 and also combine to output both outputs so that both outputs configure a half of a screen, respectively.

The digital video signal output from the graphics processing unit 52 is supplied to a video processing unit 55. The video processing unit 55 converts the input digital video signal into an analog video signal in a format possible to be displayed on the video display unit 14 and outputs the analog video signal to the video display unit 14 to make a video display.

The sound processor 53 converts an analog sound signal in a format possible to be reproduced by the loudspeaker 15 and outputs the analog sound signal to the loudspeaker 15 to make a sound reproduction.

Wherein, the broadcast receiver 11 integrally controls the whole operations including the above-mentioned various types of receiving operations by means of a control unit 56 incorporated therein. The control unit 56 has a built-in central processing unit (CPU), etc., receives operation information from the operation unit 16, or receives operation information transmitted from the remoter controller 17 and respectively controls each part so as to reflect operation contents thereto.

In this case, the control unit 56 mainly uses a read only memory (ROM) 57 with a control program to be executed by the CPU stored thereon, a random access memory (RAM) 58 to provide an operation area to the CPU and a nonvolatile memory 59 to which a variety of items of setting information and control information is stored.

The control unit 56 is connected to a card holder 61 to which the first memory 19 can be attached through a card interface 60. The control unit 56, thereby, can make information transmission to the first memory card 19 which is mounted to the card holder 61 through the card interface 60.

The control unit 56 is further connected to a card holder 63 to which a second memory card 20 can be mounted through a card interface 62. The control unit 56 thereby can make information communication with the second memory card 20 mounted to the card holder 63 through the card interface 62.

The control unit 56 is also connected to the first LAN terminal 21 through a communication interface 64. The control unit 56 thereby can perform information communication with the LAN-compatible HDD 25 connected to the first LAN terminal 21 through the communication interface 64. In this case, the control unit 56 has a dynamic host configuration protocol (DHCP) server function and assigns an internet protocol (IP) address to the LAN compatible HDD 25 connected to the first LAN terminal 21 to control the HDD 25.

The control unit 56 is further connected to the second LAN terminal 22 through a communication interface 65. The control unit thereby can make information communication with each device (refer to FIG. 1) connected to the second LAN terminal 22 through the communication interface 65.

The control unit 56 is connected to the USB terminal 23 through an USB interface 66. The control unit 56 thereby can perform information communication with each device (refer to FIG. 1) connected to the USB terminal 23 through the USB interface 66.

Furthermore, the control unit 56 is connected to the i.Link terminal 24 through an i.Link interface 67. Thereby, the control unit 56 can make information communication with each device (refer to FIG. 1) connected to the i.Link terminal 24 through the i.Link interface 67.

The control unit 56 includes a library display processing unit 56a, a retrieval screen display processing unit 56b, and a retrieval result display processing unit 56c which become important for this broadcast receiver 11.

The library display processing unit 56a displays a library including the names of a plurality of programs recorded in the video recording devices arbitrarily selected among the plurality of video recording devices. The retrieval screen display processing unit 56b displays a screen to input retrieval condition information so as to retrieve the recorded programs. The retrieval result display processing unit 56c retrieves the recorded programs matched to the retrieval conditions when the retrieval conditions are input onto the retrieval screen from recording information of the video recording devices. Then the retrieval result display processing unit 56c displays a program list including the names of the matched recorded programs, as a retrieval result screen. Moreover, these processing units 56a, 56b and 56c include a variety of functions as described later.

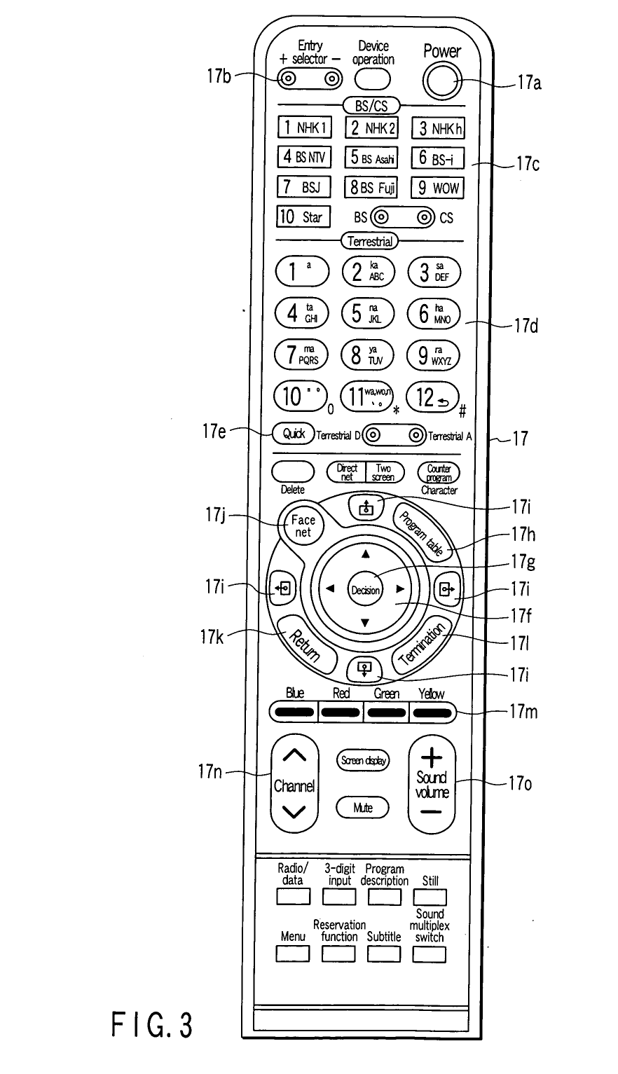

FIG. 3 shows the external view of the remote controller 17. The remote controller 17 mainly comprises a power supply key 17a, input switching keys 17b, direct tuning keys for satellite broadcast channels 17c, direct tuning keys of terrestrial broadcast channels 17d, a quick key 17e, a cursor key 17f, a destination key 17g, a program table key 17h, page switching keys 17i, a facenet (trade mark) (navigation) key 17j, a return key 17k, a terminate key 17l, colored keys in blue, red, green and yellow 117m, a channel up/down key 117n, a sound volume adjusting key 17o, etc.

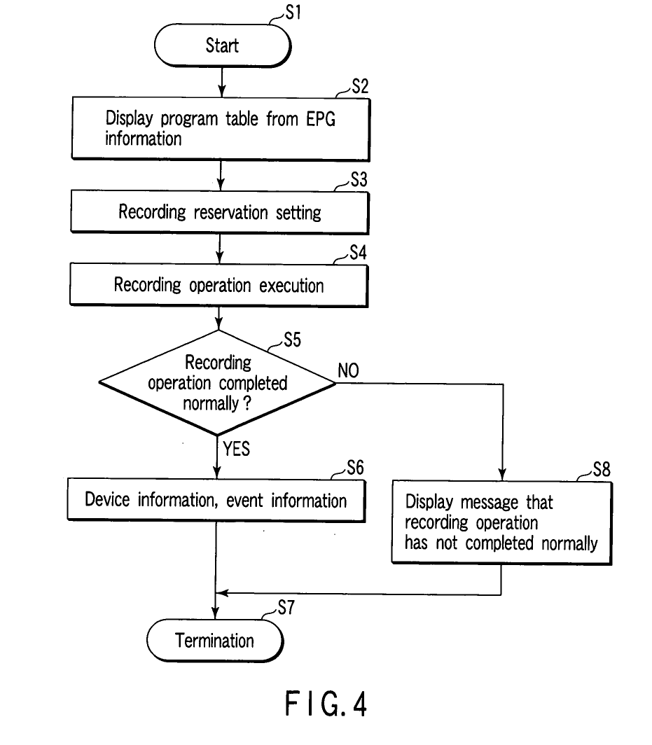

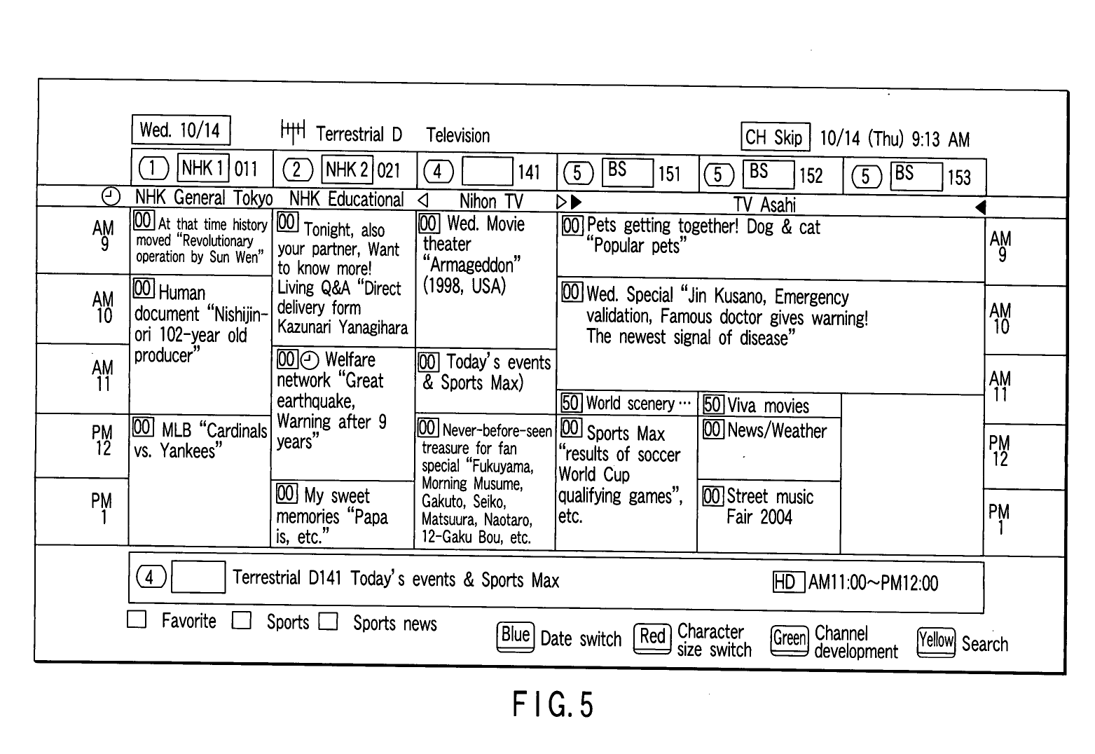

FIG. 4 shows the flowchart for explaining operations of the broadcast receiver 11 to record the program into the digital recording devices among each of the devices respectively connected to the terminals 21-24 of the broadcast receiver 11. When processing is started resulting from a request of the recording of the program (step S1), the control unit 56 displays the program table as shown in FIG. 5 on the basis of electronic program guide (EPG) information acquired from the broadcast signal (step 2).

The user then executes recording reservation setting of the desired programs on the basis of the displayed program table (step S3). In this setting, the broadcast receiver 11 selects the program to be recorded and also selects to set the digital recording devices to which the reservation-set programs are recorded, respectively.

The control unit 56 executes a recording operation so as to record the reservation-set programs into the reservation-set digital recording devices when it has reached the preset times for recording reservations (step S4).

The control unit 56 then determines whether or not the program recording operation has normally completed, and if it is determined that the operation has completed normally (Yes, in step S5), the broadcast receiver 11 records device information (device IDs, device names, shared holder names, etc.) to specify the digital recording devices which have performed recording and event information (event IDs, channel number, titles, content explanation, categories, recording ranges, image quality modes, etc.) related to the recorded programs into the nonvolatile memory 59 (step S6) and terminates this processing (step S7).

If it is determined that the operation has not completed normally (No, in step S5), the control unit 56 displays the message indicating the fact that the operation has not completed normally onto the display unit 14 (step S8) and terminates this processing (step S7).

According to recording operations described above, the user can arbitrarily select a plurality of digital recording devices connected to each terminal 21-24 of the broadcast receiver 11 and record programs sequentially.

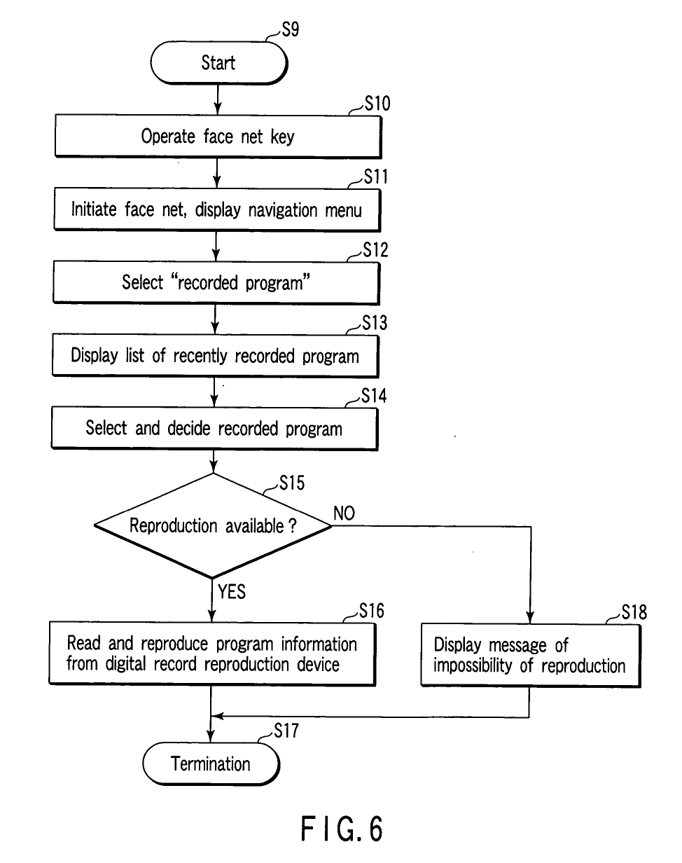

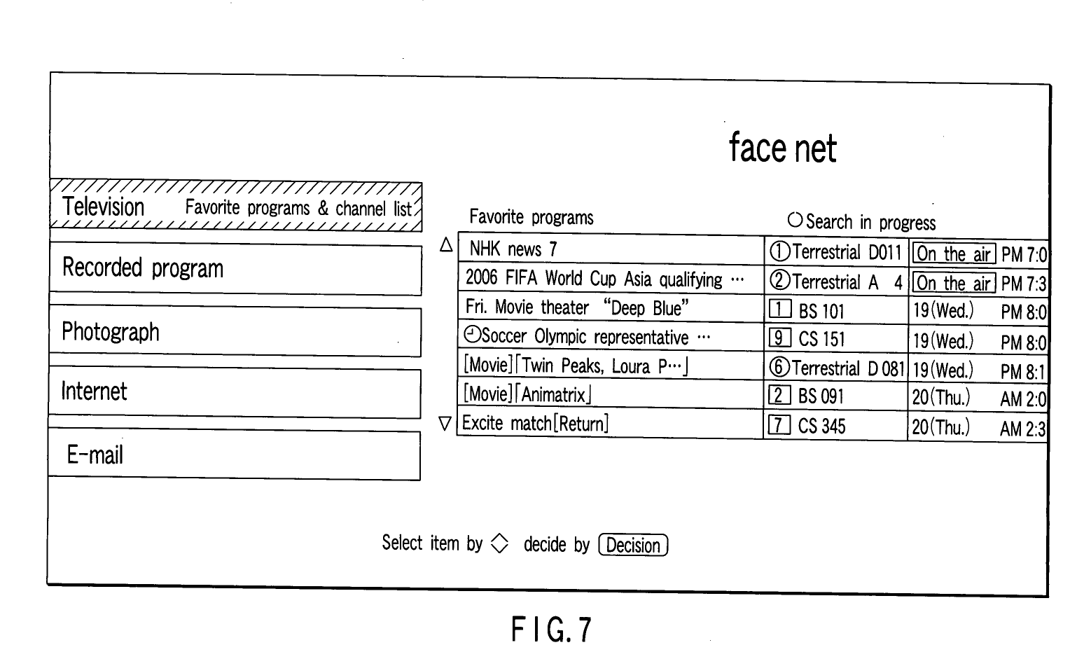

FIG. 6 shows the flowchart for explaining operations to quickly retrieve the desired program among a variety of programs recorded in the plurality the digital recording devices and reproduce the retrieved programs, as mentioned above. When the processing stars (step S9), the user operates the “facenet” key 17j of the remote controller 17 (step S10). (Note: facenet is a graphical guide screen for the user.) The control unit 56 then starts up the facenet (navigation) and displays the navigation menu as shown in FIG. 7 onto the video display unit 14 (step S11).

Five items “Television”, “Recorded program”, “Photograph”, “Internet” and “E-mail” are selectively provided in this menu. The selected items are displayed on a screen in different color from those of other items, and a state in which the item “Television” is selected is indicated by hatching in FIG. 7.

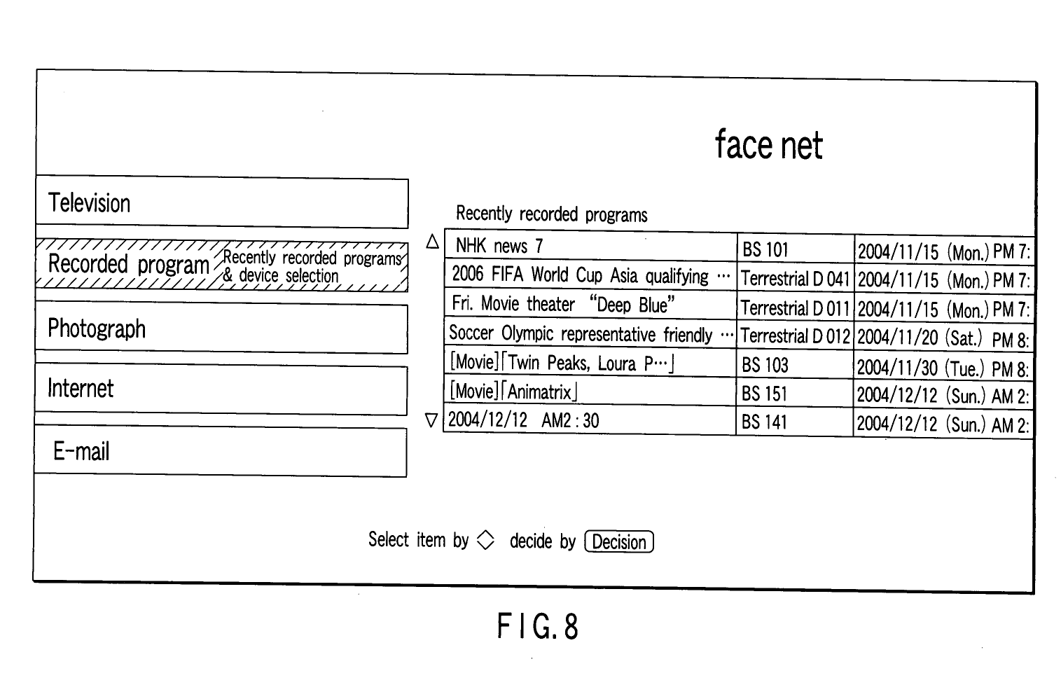

Here, it is assumed that the user operates the cursor key 17f on the remote controller 17 and selects the item of “Recorded program” (step 12). The control unit 56 then is brought into a state of selection of the item “Recorded program” as shown in FIG. 8.

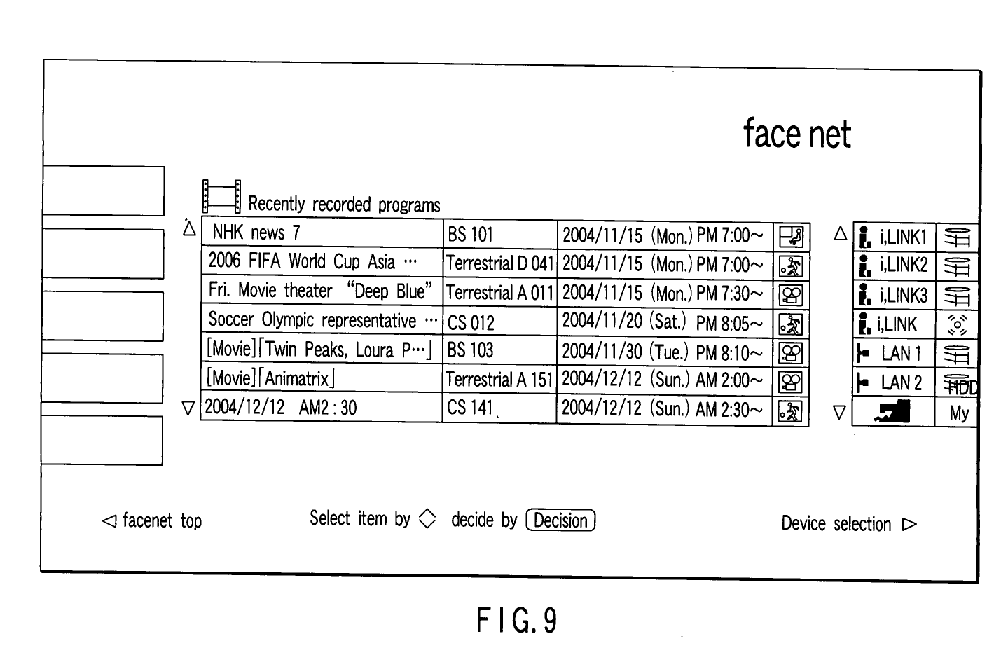

In this state, when the user operates the determination key 17g of the remote controller 17 (step S13), the control unit 56 displays a list of the recently recorded programs onto the video display unit 14 as shown in FIG. 9. In this program list, the title, broadcast channel, recording date, day of the week, time, category, etc., are displayed as information indicating the recorded program.

The list of the recently recorded programs is created by referring to equipment information specifying the digital recording devices which have recorded and event information in relation to recorded programs recorded on the nonvolatile memory 59 in reservation recording of the programs which has been explained in FIG. 4. In this list, it is possible to display information indicating thirty-five programs at a maximum as far back as the reproduction-requested program recorded therein, regardless of the digital recording devices with the programs recorded therein. Having displayed seven programs in a list form in FIG. 9, the user can see the list of thirty-five programs by operating the cursor key 17f to scroll the display. If the user operates the page switching keys 17i of the remote controller 17, the user can skip the seven programs displayed in a list at once.

When the user operates the cursor key 17f of the remote controller 17 to select information indicating the desired program from the list of the recently recorded programs and operates the decision key 17g to decide it (step S14), the control unit 56 specifies the digital recording devices with the selected and decided programs recorded therein from information recorded in the nonvolatile memory 59 and decides whether or not the program is possible to be reproduced (step S15).

This decision determines whether the program can be reproduced or not by comprehensively comparing various conditions in recording and in reproducing, for example, by determining whether or not the broadcast receiver 11 is connected to the digital recording device with the reproduction-requested program recorded therein, whether or not power is turned on to the digital recording device with the reproduction-requested program recorded therein, whether or not the program is still recorded in the targeted digital recording device, etc.

If it is determined that the program can be reproduced (Yes, in step S15), the control unit 56 reads out information about the reproduction-requested program from the targeted digital recording device and controls the broadcast receiver 11 to reproduce the program (step S16) then terminates this processing (step S17).

If it is determined that the program can not be reproduced (No, in step S15), the control unit 56 displays a message indicating the fact that the requested program can not be reproduced onto the video display unit 14 and terminates this processing (step S17).

According to the forgoing reproduction operations, since the broadcast receiver 11 has a navigation function to display, in a list, the thirty-five recorded programs at a maximum as far back as from the newest recorded program regardless of the digital recording device with the desired program recorded therein, the user can easily manage the programs recorded in the plurality of digital recording devices. Accordingly, it becomes possible to quickly retrieve and reproduce the desired program by selecting the program by means of the cursor key 17f and deciding the program by means of the decision key 17g among programs displayed in a list form.

Considering the increase in the number of connected sets of the digital recording devices and the recorded programs, it becomes impractical to display in a list the whole of the programs recorded in the plurality of the recording devices. As the embodiment stated above, it is a practical setting to hardly cause a substantial trouble for the user to display in a list up to the thirty-five programs at a maximum as far back as from the newest recorded program.

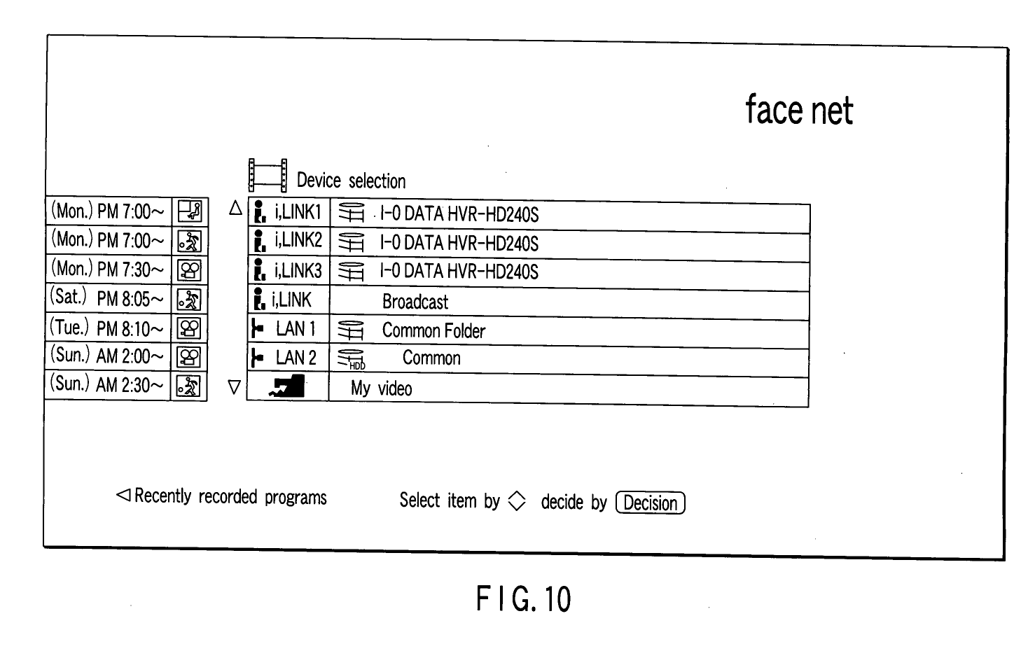

The broadcast receiver 11, as shown in FIG. 10, can display the list screen of the connected devices by scrolling the screen on the right side of the list table of the recently recorded program shown in FIG. 9. In this list screen of the connected devices, the whole of the devices connected to each terminal 21-24 (however, if a broadband router 31 is connected, not the whole but up to the router 31) can be made in a list display.

In this list shown in FIG. 10, an icon indicating that the LAN 1 is a LAN compatible HDD dedicated port is marked to the LAN 1 corresponding to the first LAN terminal 21, and an icon indicating that the LAN 2 is a generic LAN compatible port is marked to the LAN 2 corresponding to the second LAN terminal 22.

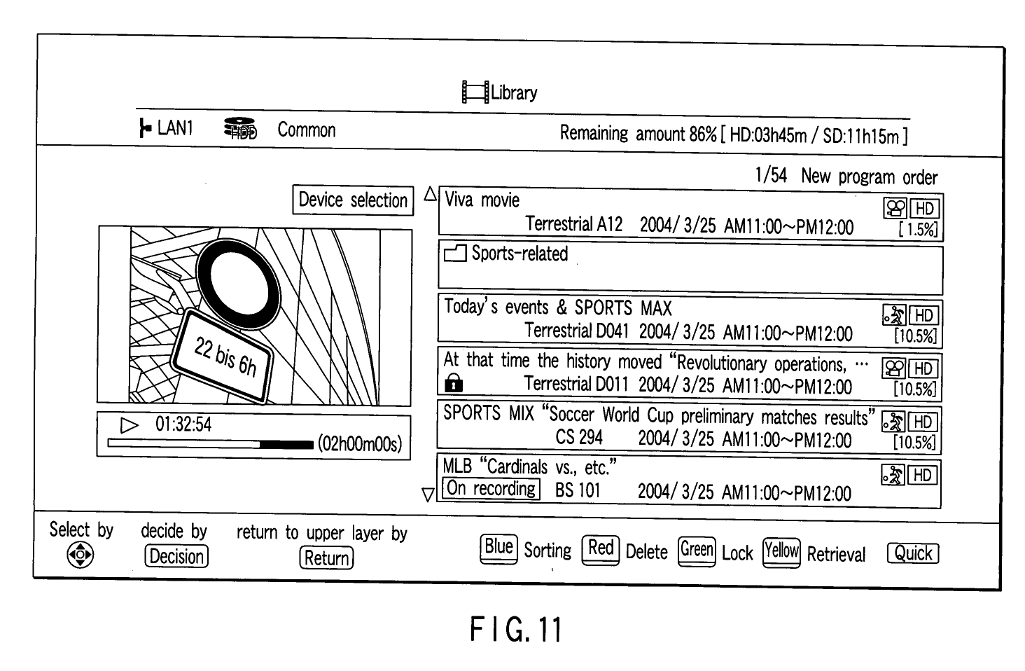

If the user selects the desired digital video recording devices from the display screen of the connected device list and decides by the decision key 17g, the list of the programs recorded in the selected and decided digital video recording devices is displayed as a library as shown in FIG. 11. In this case, the library display processing unit 56a is in operation.

The broadcast receiver 11 can switch the video displayed on the screen of the video display unit 14 on a page basis by operating the page switching keys 17i of the remote controller 17. Otherwise stated, the cursor key 17f of the remote controller 17 is composed of four keys corresponding to each direction of up, down and right, left so as to move the cursor up, down and right, left on the screen.

In other words, for example, if the user operates the page switching keys 17i corresponding to the cursor key 17f to move the cursor upward, a current display screen can be switched to the video existent on the upper side of the display screen. Owing to this page switching function, it becomes possible to select the desired screen in shorter time than when scrolling the screen by operating the cursor key 17f.

Since the page switching keys 17i are provided in accordance with the cursor key 17f, the moving directions can be easily recognized by the user. The page switching keys 17i can switch such screens of the program table shown in FIG. 5 and can switch the list of recently recorded programs shown in FIG. 9.

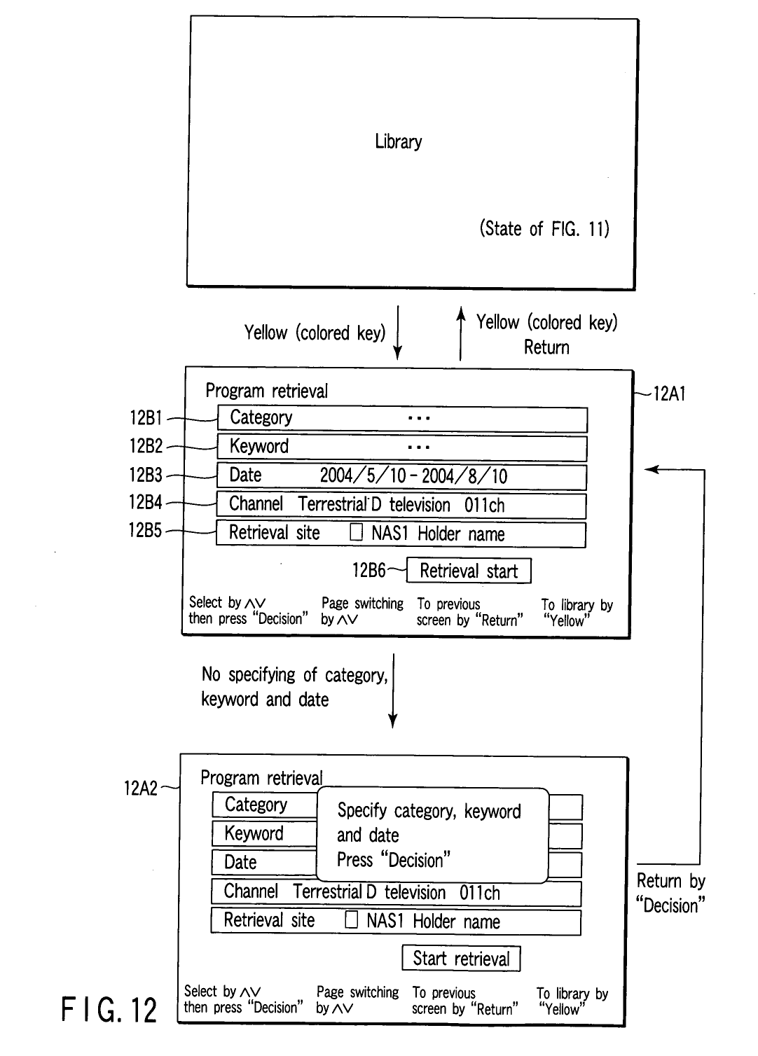

The broadcast receiver 11 displays a program retrieval screen 12A1 as shown in FIG. 12 by operating the colored key in yellow 117m of the remote controller 17 in the display status of the program table shown in FIG. 11. At this time, the retrieval screen display processing unit 56b is in operation.

That is, if the user operates the colored key in yellow 117m of the remote controller 17 in the display state of the library screen (FIG. 11), the program retrieval screen 12A1 as shown in FIG. 12 is displayed. In this program retrieval screen, the user can input each item 12B1, 12B2, 12B3, 12B4 and 12B5 of the category, keyword, data, channel and retrieval site can be input, respectively. When the retrieval site 12B5 is instructed, the broadcast receiver 11 starts to retrieve the corresponding program. As the result from the retrieval, the programs matching to the retrieval conditions are retrieved and displayed in a list form.

In this case, if the category, keyword, data, etc. are not specified, an alert screen 12A2 is displayed and a message “Please input category, keyword and data” is displayed.

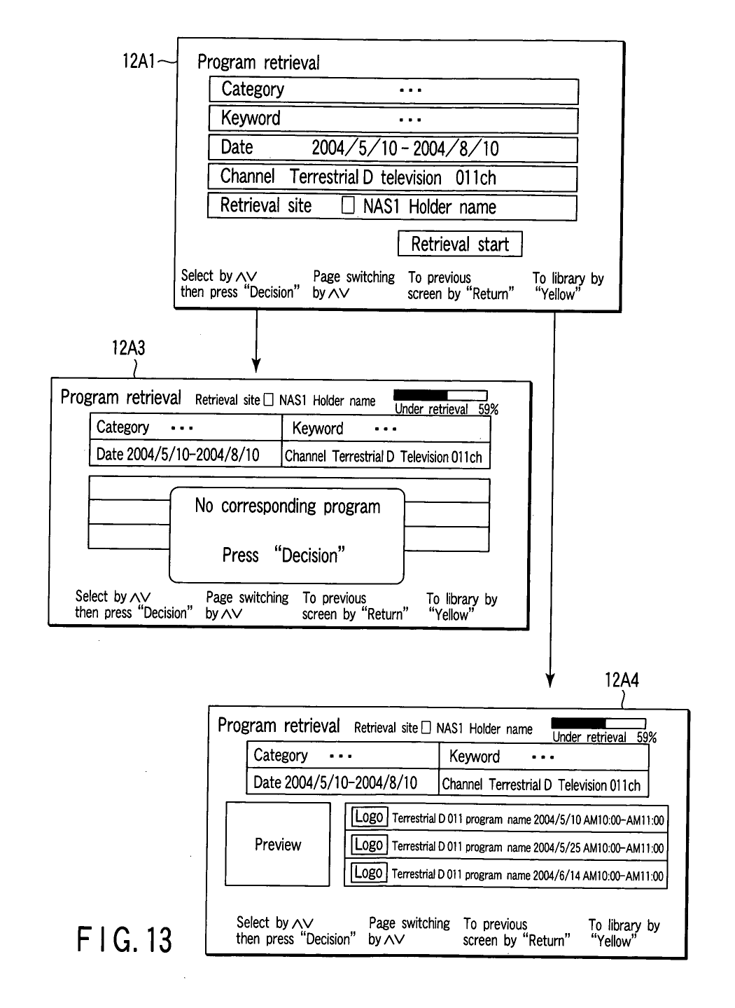

If the retrieval conditions are sufficiently input, the program retrieval is executed. As the retrieval result, if any program has not found, a message “Corresponding program has not been found” is displayed as shown on a screen 12A3 in FIG. 13. At this moment, if the user presses the decision key 17g (FIG. 3) the program retrieval screen returns to the screen 12A1.

If the corresponding program has been found, the program list including information about the names of the programs and the data in relation to the recorded programs is displayed. Regarding the program has been found firstly, a preview is performed. At this time, the retrieval result display processing unit 56c is in operation.

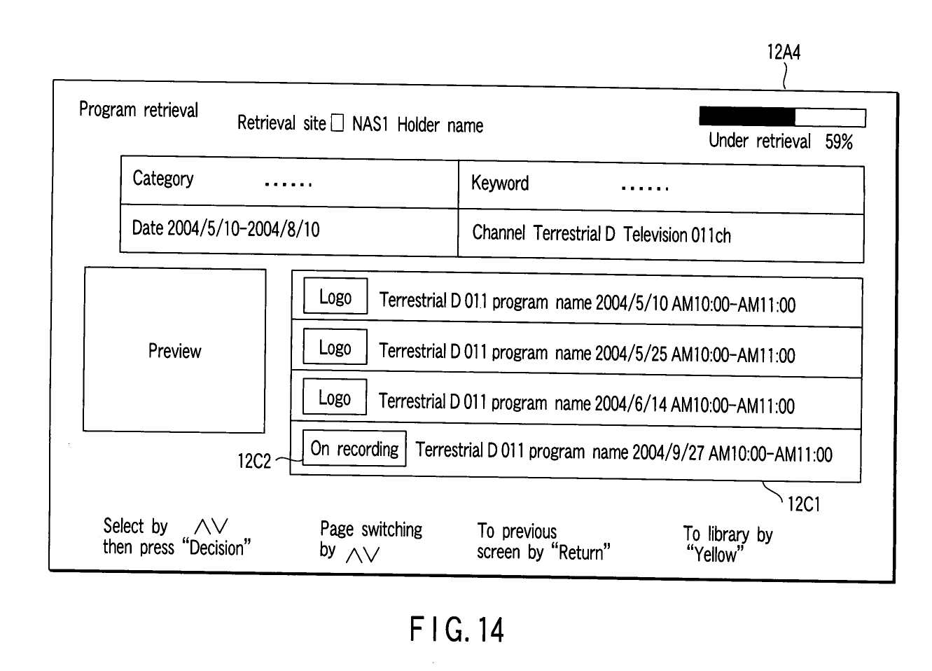

The broadcast receiver regarding the present invention, can display even the name of the program which is currently recording onto the program retrieval screen while executing the program retrieval. FIG. 14 shows an aspect in which information 12C1 about the program which is currently recording is displayed on the program retrieval screen 12A4. In addition, a character or a mark 12C2 indicating the state in recording is displayed in the information 12C1.

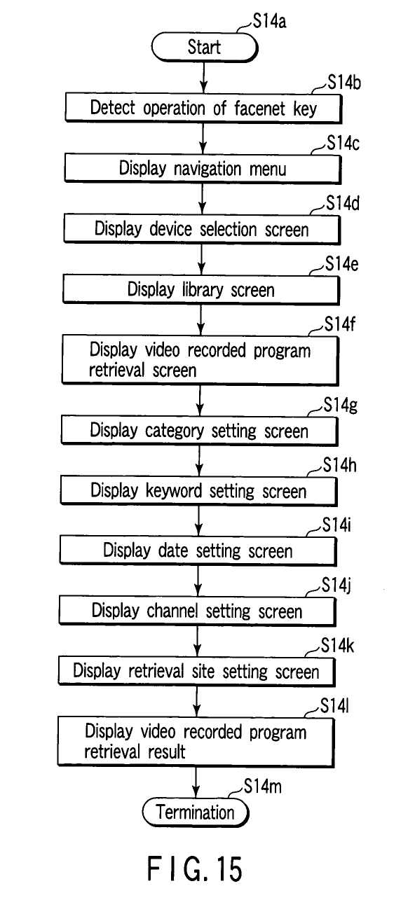

Hereinafter, the program retrieval function will be explained more specifically. FIG. 15 shows the flowchart for explaining the retrieval operations by means of this recorded program retrieval function. When the user operates the facenet key 17j of the remote controller 17, these operations are started (step S14a). When the control unit 61 detects the operation of the facenet key 17j (step S14b), the facenet (navigation) is activated and the navigation screen shown in FIG. 8 is displayed on the video display unit 14 (step S14c).

The navigation screen displays five items of “Television”, “Recorded program”, “Photograph”, “Internet” and “E-mail”. The user operates the cursor key 17f of the remote controller 17 to select a desired item and operates the determination key 17g, so that the user can select the items. The selected item is displayed on the screen in a manner that the selected item is displayed by being colored differently from other items.

When the user selects the item of “Recorded program” and selectively set the item of “Device selection”, the control unit 56 displays the device selection screen shown in FIG. 10 (step S14d).

The device selection screen displays a variety kinds of devices connected to the first and the second LAN terminals 21, 22, the USB terminal 23 and the i.Link terminal 24 or the memory cards 19, 20 mounted on the card holders 66, 68 in a list form on the basis of the latest information recognized by the control unit 56. Thereby, the user can select the desired device or memory card from the device selection screen.

When detecting the fact that a specified digital video recording device (for example, the HDD 25 being the NAS connected to the first LAN terminal 21) has been selected, the control unit 56 displays the library screen shown in FIG. 11 by inquiring to the HDD 25.

The library screen displays a list of all programs recorded in the HDD 25. In this case, the title, channel, recorded date, category, video quality, etc. are displayed for each program, respectively. In this library screen, the program now in recording also can be displayed with an icon of “Under recording”.

In the case of this library screen, six programs at a maximum can be displayed on one screen, if programs with the number more than six have been recorded, the library screen can display all programs with scrolling up and down by operating the cursor key 17f.

The HDD 25 can store the programs in a folder form. The recorded programs can be managed hierarchically in a manner that, for example, a folder of “sports-related” is created, folders of “Olympic”, “town athletic meeting”, etc., are created under the folder of “sports”, and folders of “marathon”, “swimming”, etc., are created under the folder of “Olympic”. On the library screen shown in FIG. 11, if any folder has been created, the upper-most folder (“sports-related” in FIG. 11) should be displayed.

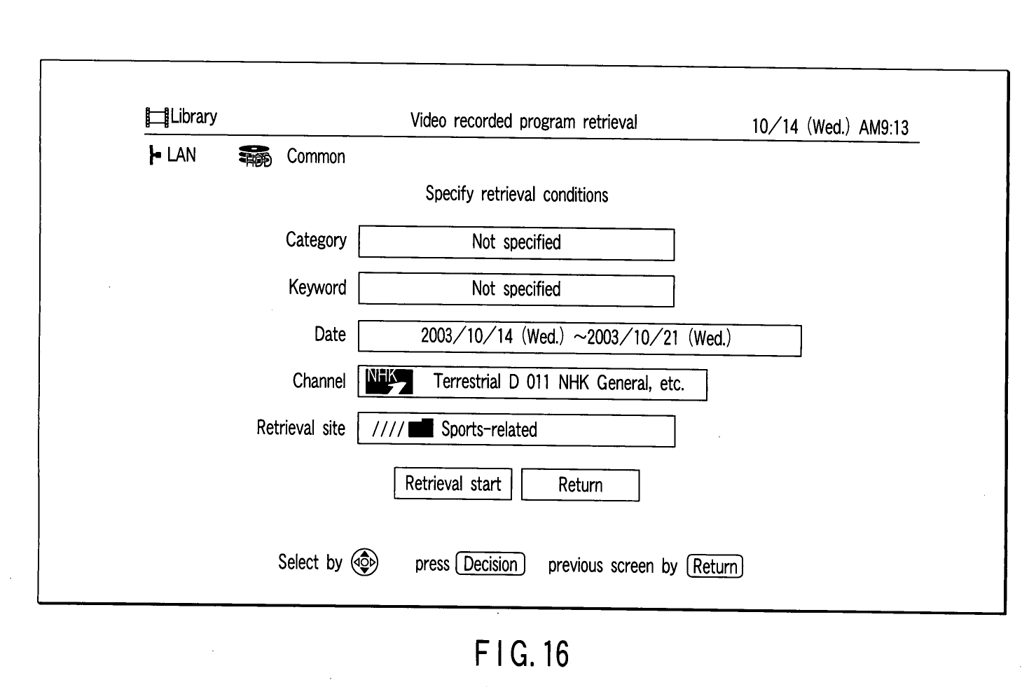

When detecting the fact that the colored key in yellow 117m of the remote controller 17 is operated during the display of the library screen, the control unit 56 displays the recorded program retrieval screen as shown in FIG. 16 (step S14f).

On the recorded program retrieval screen, five retrieval conditions of “category”, “keyword”, “date”, “channel” and “retrieval site” can be set. The control unit 56 retrieves the program corresponding to at least one of five retrieval conditions among all programs displayed on the library screen, that is, all programs recorded in the HDD 25.

It is possible to set the retrieval conditions so as to retrieve a plurality of kinds of combinations not all kinds of five retrieval conditions, that is, the programs corresponding to AND or OR of any two, any three or any four of retrieval conditions. It is possible to set the retrieval conditions so as to retrieve the programs corresponding to AND or OR of all of five retrieval conditions. These setting are achieved through operations by the user.

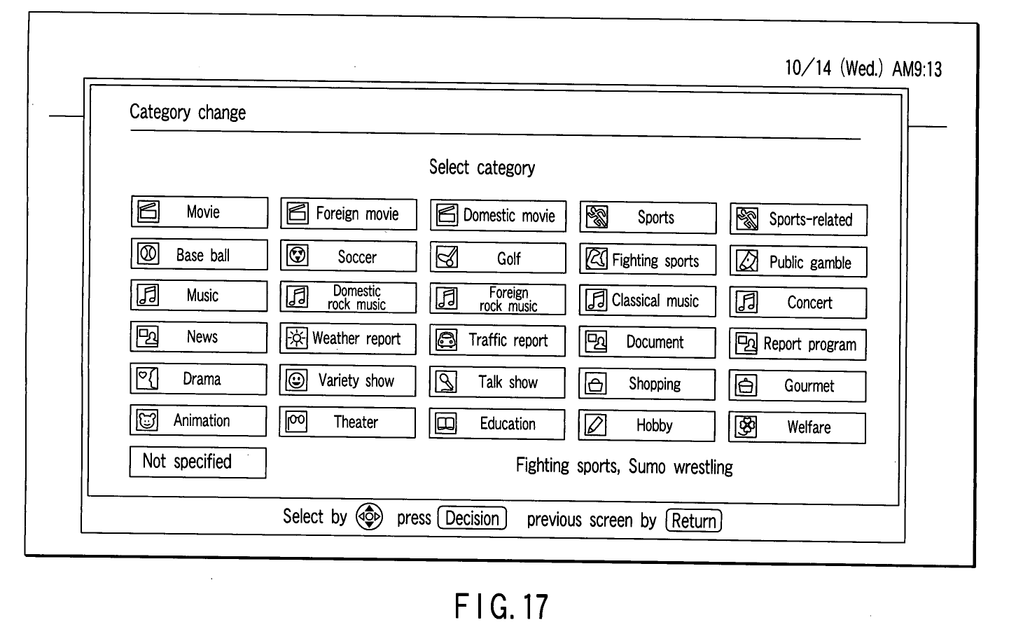

In other words, when the user selects “category” as the retrieval condition among the recorded program retrieval screen, the control unit 56 displays the category setting screen as shown in FIG. 17 (step S14g).

The category setting screen makes a list display for the items indicating a plurality of categories such as “movie”, “foreign movie”, “domestic movie” and “sports”, the user can select the item corresponding to any category and retrieve the program in response to the set category. It is also possible for the user not to specify any category as the retrieval condition by selecting the item “not specified”.

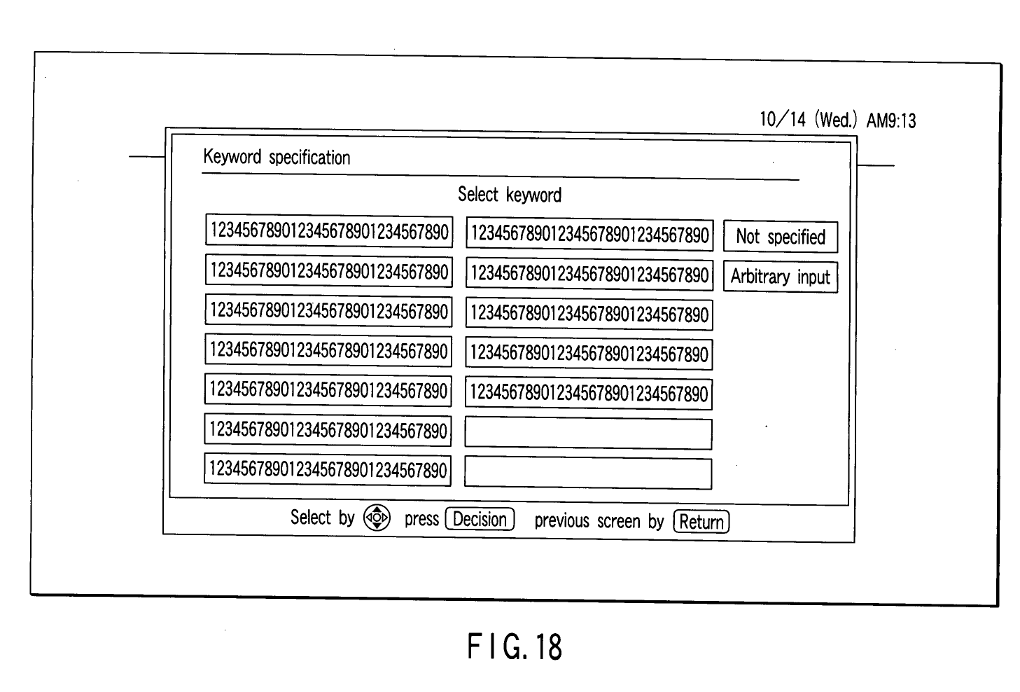

If the user correctly completes the setting of the category, or if the user operates the return key 17k of the remote controller 17, the broadcast receiver 11 returns again to the recorded program retrieval screen shown in FIG. 16. If selecting the item “keyword” as the retrieval condition on the recorded program retrieval screen, the control unit 61 displays the keyword setting screen as shown in FIG. 18 (step S14h).

In this keyword setting screen, the user can set fourteen keywords at a maximum, and can perform the program retrieval, for example, on the basis of AND of the set up keywords. It is also possible for the user no to specify any keyword as the retrieval conditions by selecting the item “not specified”.

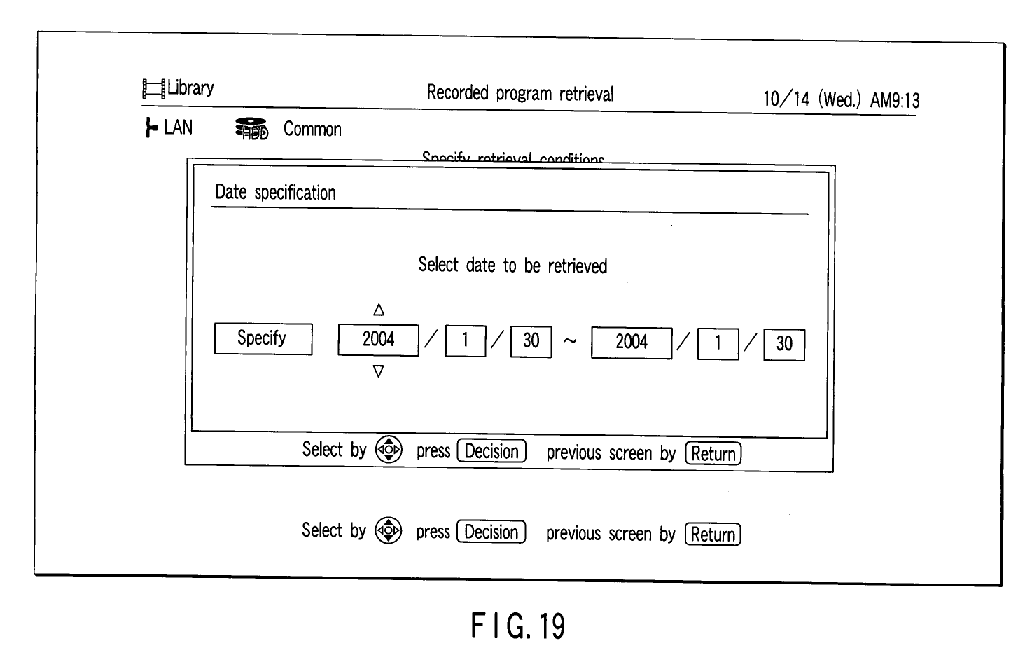

If the user correctly sets any keyword, or operates the return key 17k of the remote controller 17, the broadcast receiver 11 returns again to the recorded program retrieval screen shown in FIG. 16. If the user selects “date” as the retrieval conditions on the recorded program retrieval screen, the control unit 56 displays the date setting screen as shown in FIG. 19 (step S14i).

On the date setting screen, the user can set a specified date or a certain period from one date to the other date, and retrieve the program which has been recorded on the set up date or period.

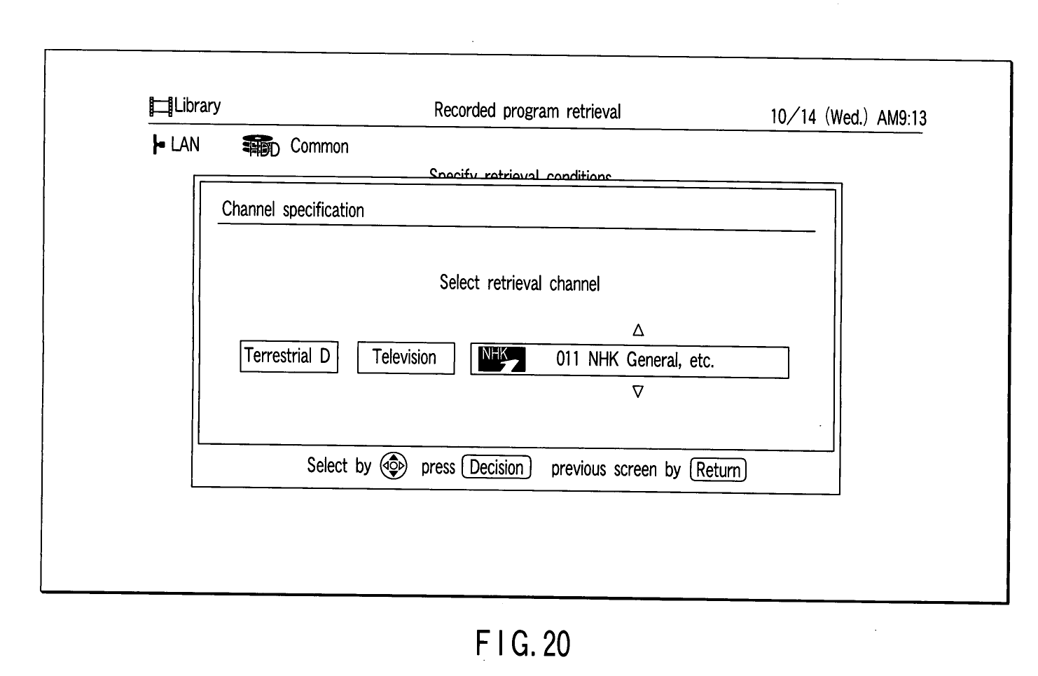

If the date has been correctly set, or if the return key 17k of the remote controller 17 has been operated, the date setting screen is returned again to the recorded program retrieval screen shown in FIG. 16. If the user selects “channel” as the retrieval condition from the recorded program retrieval screen, the control unit 56 displays the channel setting screen as shown in FIG. 20.

On this channel setting screen, the user can set any channel for each mode of broadcasting such as a terrestrial digital broadcast, and retrieve the program recorded on the set up channel.

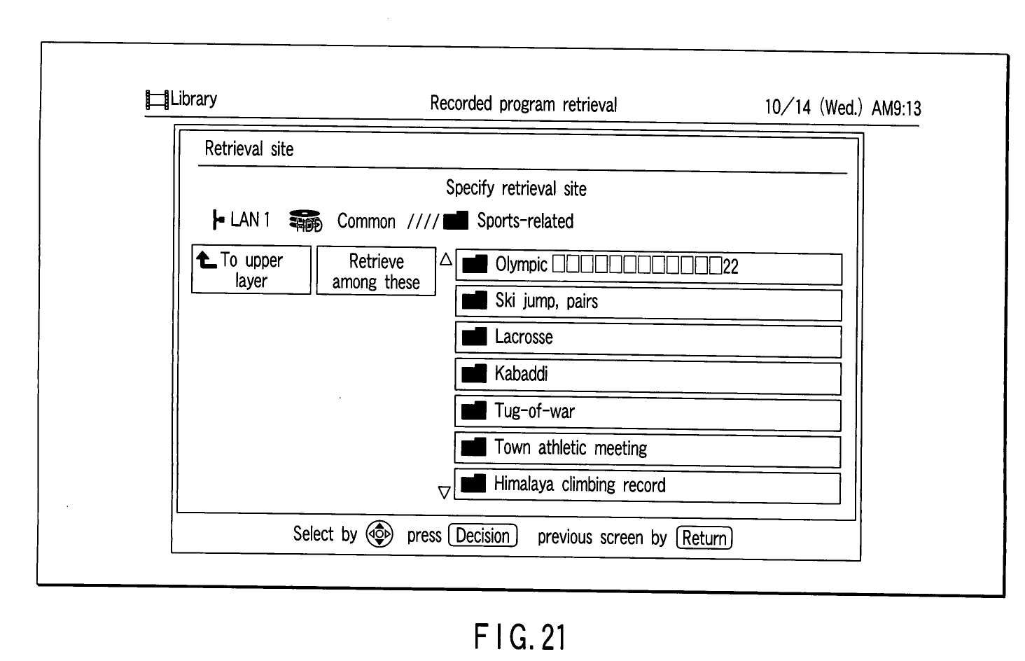

If the channel has been correctly set, or if the return key 17k of the remote controller 17 has been operated, the channel setting screen is returned again to the recorded program retrieval screen shown in FIG. 16. Then, if the user selects “retrieval site” as the retrieval condition from the recorded program retrieval screen, the control unit 56 displays such a retrieval site setting screen shown in FIG. 21.

On this retrieval site setting screen, the user can set the retrieval site for specifying a holder used to execute the program retrieval independently of the layer, the user can perform the program retrieval subject to the conditions, namely, the category, keyword, date and channel in the set up one or more holders.

If the retrieval site has been correctly set, or if the return key 17k of the remote controller 17 has been operated, the retrieval site setting screen is returned again to the recorded program retrieval screen shown in FIG. 16.

As stated above, the user can respectively set five retrieval conditions. The user can set the conditions for five retrieval conditions in any order without having to set in such an order as category, keyword, date, channel and retrieval site as described above.

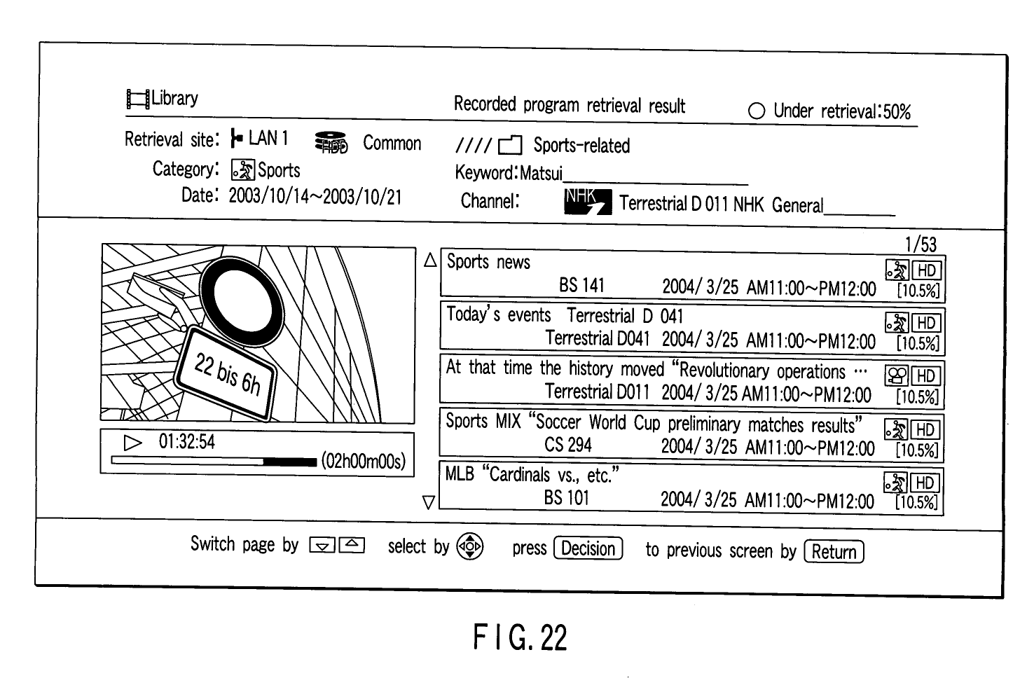

In such a state with five retrieval conditions set therein, if the user selects the item “retrieval start” from the recorded program retrieval screen, the control unit 56 executes the program retrieval based on the five retrieval conditions for all programs recorded in the HDD (step S14l). This program retrieval is achieved when the user makes inquiries to the HDD 25. When the program retrieval is completed, the control unit 56 displays such a screen of the recorded program retrieval result shown in FIG. 22 and terminates this processing (step S14m).

On the screen of the recorded program retrieval result, the list of the programs retrieved on the basis of specified digital video recording devices or recording medium (HDD 25 in this case) and five retrieval conditions.

The broadcast receiver 11 has a function able to select a desired program by operating the cursor key 17f of the remote controller 17 from the screen of the recorded program retrieval result displayed as mentioned above and reproduce the program by operating the decision key 17g.

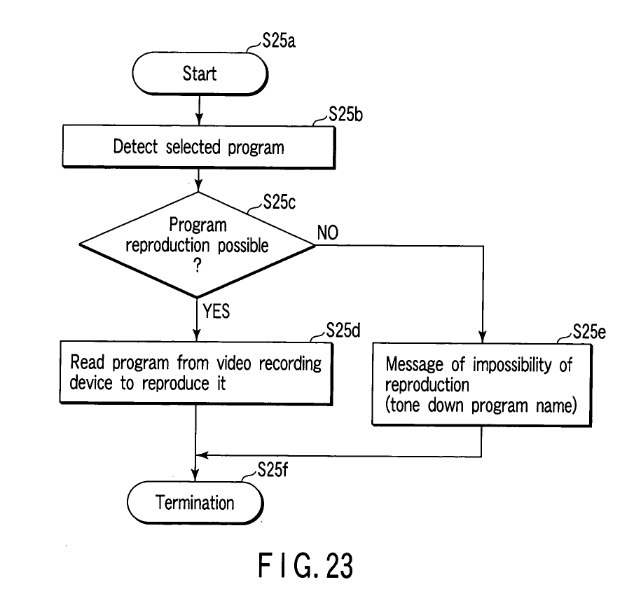

FIG. 23 shows the flowchart for explaining the operations to reproduce the selected program. When the operations have started (step s25a), the control unit 56 detects the program selected on the screen of the recorded program retrieval result (step S25b), and discriminates whether the program can be reproduced or not from the digital video recording device with the selected program recorded therein (step S25c).

In this discrimination, for example, it is decided, for example, that the format of the recorded program is matched to the video display on the broadcast receiver 11, or that the program file of the recorded program is broken.

If the control unit 56 determines that the recorded program can be reproduced (Yes, in step S25c), the control unit 56 reads the information on the program to be required for reproduction from the targeted digital video recording device and controls the video recording device to reproduce the program (step S25e) then terminates this processing (step S25f).

If the control unit 56 determines that the recorded program cannot be reproduced (No, in step S25c), the control unit 56 displays the message indicating the fact that the program to be required for reproduction cannot be reproduced on the video display unit 14 (S25e) then terminates this processing and times out the message (step s25f).

The forgoing embodiment specifies the connected digital video recording device or the recording medium such as a memory card, sets the retrieval conditions such as category, keyword, date, channel and retrieval site, and makes the recorded programs matching to the retrieval conditions possible to be retrieved from the specified video recording device or recording medium. So that, the embodiment can quickly retrieve the desired recorded programs from a plurality of video recording devices connected with a network.

Although the foregoing embodiment specifies a specific video recording device or recording medium from a plurality of video recording devices connected with a network and retrieves the program from the specified video recording device or recording medium on the basis of the retrieval conditions, it is understood that the invention is not limited to the above-mentioned embodiment thereof. It is possible, for example to construct a server for integrally control all video recording devices and recording media, on a network, and execute the program retrieval based on the retrieval conditions for all recorded devices and recording media connected with a network.

As stated above, the broadcast receiver comprises connection terminals to which a plurality of video recording devices are connected, a library display means for displaying a library including the program names of the plurality of programs recorded in arbitrarily selected video recording devices among the plurality of video recording devices, a retrieval screen display means for displaying a screen on which the retrieval conditions to retrieve the recorded programs are input, and a retrieval result displaying means for retrieving the recorded programs matching to the retrieval conditions from recording information on the selected video recording devices and displaying a program list including the names of the retrieved programs, as a retrieval result screen.

The means for starting reproduction of the retrieved program are available in a variety of embodiments of the invention. For example, the retrieval result display means includes a means for displaying at least program names of the retrieved programs side by side in order in a program list on the retrieval result screen and displaying a preview for the firstly retrieved program. Further, the retrieval result display means includes a means for displaying at least program names of the retrieved programs side by side in order in a program list of the retrieval result screen and starting a preview for the desired program with a cursor put thereon. It is preferable for a reproduction key to be operated when the user puts the cursor on the position of the name of the desired program. The reproduction means may have a function to give cues for the programs in order of the programs listed in the program list on the retrieval result screen and execute the reproduction. Being left without change just after the completion of the program retrieval, the reproduction means, further, may have a function to reproduce programs in inverse order they were video-recorded from the program list of the retrieval result screen.

The retrieval result displaying means may have a means for displaying at least program names of the retrieved programs side by side in order in the program list on the retrieval resulting screen and starting a preview when the cursor is put on the position of the name of the desired program and a means for displaying the message indicating the fact that the program cannot be produced when the cursor is put on the position of the name of the program impossible to be reproduced. The message disappears after the elapse of a prescribed time. The retrieval result display means may have a means for displaying at least program names of the retrieved programs side by side in order and starting the preview when the reproduction operation is executed by putting the cursor on the position of the program name and a means for displaying the program name impossible to be reproduced in a tone-down manner.

It is our intention that the invention is not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from the whole of the constituent elements shown in the embodiments mentioned above. Further, the constituent elements over different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcast receiver, comprising:
a connection terminal configured to connect a plurality of video recording devices;
a library display processing unit configured to display a library including names of a plurality of programs recorded in an arbitrarily selected video recording device among the plurality of video recording devices;
a retrieval screen display processing unit configured to display a screen to which retrieval condition information is input for retrieving recorded programs; and
a retrieval result display processing unit configured to retrieve recorded programs matching retrieval conditions when the retrieval conditions are input to the retrieval screen and displaying a program list including names of the recorded programs matching to the retrieval conditions, as a retrieval result screen.

2. The broadcast receiver according to claim 1, wherein the retrieval result display processing unit includes a function of displaying while including even names of programs under video recording into a program list on the retrieval result screen.

3. The broadcast receiver according to claim 2, wherein the retrieval result display processing includes a processor for displaying names of the programs by putting a mark or characters indicating the fact of under video recording so as to identify that the programs are under video recording when displaying even the names of the programs under recording while including the names into the program list on the retrieval result screen.

4. The broadcast receiver according to claim 1, wherein the retrieval result display processing includes a processor for displaying at least program names of retrieved programs side by side in order into the program list on the retrieval result screen and displaying a preview of a firstly retrieved program.

5. The broadcast receiver according to claim 1, wherein the retrieval result display processing unit includes a processor for displaying at least program names of retrieved programs side by side in order in the program list on the retrieval result screen and starting a preview when a cursor is put on a position of a program name.

6. The broadcast receiver according to claim 1, wherein the retrieval screen display processing unit is set to be initiated when a colored key of a remote controller is operated.

7. The broadcast receiver according to claim 1, wherein the broadcast receiver further has a function, as a reproduction processing unit, of giving cues for the programs in order they were listed in the program list on the retrieval result screen.

8. The broadcast receiver according to claim 1, wherein the broadcast receiver further has a function, as a reproduction processing unit, of reproducing the programs in inverse order they were video-recorded from the program list on the retrieval result screen.

9. The broadcast receiver according to claim 1, wherein the retrieval result display processing unit includes:
a means for displaying at least program names of the retrieved programs in the program list on the retrieval result screen and starting a preview when a cursor is put on a position of a program name to perform a reproduction operation; and
a means for displaying a message indicating the fact that a program is impossible to be reproduced when the cursor is put on a name of the program impossible to be reproduced.

10. The broadcast receiver according to claim 1, wherein the retrieval result display processing unit includes:
a means for displaying at least program names of the retrieved programs in the program list on the retrieval result screen and starting a preview when a cursor is put on a position of a program name to perform a reproduction operation; and
a means for displaying a name of a program impossible to be reproduced in a tone-down manner.

11. A control method for a television broadcast receiver comprising a control unit for integrating operations of the broadcast receiver, a receiving unit for receiving a broadcast signal on the basis of control of the control unit, a demodulation and signal processing unit for demodulating and processing the received signal to convert it into a display signal, a video recording processing unit for performing record processing the display signal to a recording medium in response to an operation input and a connection terminal to which a plurality of video recording devices are connected, wherein the control method for the broadcast receiver comprises:
displaying a library including program names of a plurality of programs recorded in arbitrarily selected video recording devices among the plurality of video recording devices;
displaying a screen to which retrieval condition information is input for retrieving recorded programs; and
retrieving video recorded programs matching to the retrieval conditions from recorded information of the selected video recording device when retrieval conditions are input onto the retrieval-screen and displaying a program list including names of the video recorded programs matching the retrieval conditions, as a retrieval result screen.

12. The control method for the broadcast receive according to claim 11, wherein a step of displaying the retrieval result screen displays even program names under video recording while including them into the program list on the retrieval result screen.

13. The control method for the broadcast receiver according to claim 12, wherein a step of displaying the retrieval result screen displays program names under recording by putting a mark or characters indicating the fact that programs are under video recording so as to identify programs under video recording when displaying even the program names under video recording by including them into the program list on the retrieval result screen.

14. The control method for the broadcast receiver according to claim 11, wherein a step of displaying the retrieval result screen displays at least program names of the retrieved programs side by side in order in the program list of the retrieval result screen and displays a preview of a firstly retrieved program.

15. The control method for the broadcast receiver according to claim 11, wherein a step of displaying the retrieval result screen displays at least program names of the retrieved programs side by side in order and starts a preview when a cursor is put on a position of a program.

16. The control method for the broadcast receiver according to claim 11, wherein a step of displaying the retrieval result screen is set to be initiated when a colored key of a remote controller is operated.

17. The control method for the broadcast receiver according to claim 11, wherein the method gives cues for programs in order they were listed side by side in the program list on the retrieval result screen, as reproduction processing.

18. The control method for the broadcast receiver according to claim 11, wherein the method reproduces the programs in inverse order they were video-recorded in the program list on the retrieval result screen, as reproduction processing.

19. The control method for the broadcast receiver according to claim 11, wherein a step of displaying the retrieval result screen
displays at least program names of the retrieved programs side by side in order in the program list on the retrieval result screen;
starts a preview when a cursor is put on a position of a program name to perform a reproduction operation; and
displays a message indicating the fact that the program is impossible to be reproduced when the cursor is put on a name of a program impossible to be reproduced.

20. The control method for the broadcast receiver according to claim 11, wherein a step of displaying the retrieval result screen
displays at least program names of the retrieved programs side by side in order in the program list on the retrieval result screen;
starts a preview when a cursor is put on a position of a program name to perform a reproduction operation; and
displays a name of a program impossible to be reproduced in a tone-down manner.
